(19) United States
(12) Patent Application Publication
(10) Pub. No.: US 2004/0216149 A1
(43) Pub. Date: Oct. 28, 2004

(54) Content exporting from one application to another

(76) Inventors: Larry E. Reitz, Boise, ID (US); Brett A. Smith, Boise, ID (US); Andrew P. Alegria, Nampa, ID (US)

Correspondence Address: HEWLETT-PACKARD COMPANY, Intellectual Property Administration, P.O. Box 272400, Fort Collins, CO, 80527-2400, US

(21) Appl. No.: 10/286,557

(22) Filed: Oct. 31, 2002

Related U.S. Application Data
(63) Continuation-in-part of application No. 10/198,336, filed on Jul. 16, 2002.

(51) Int. Cl. G06F 9/46

(52) U.S. Cl. 719/329

(57) ABSTRACT

Disclosed are systems and methods for exporting content. In one embodiment, a system and a method pertain to determining user content and destination selections based upon content dragged to and dropped on an icon representing a destination application, copying the selected content, and inserting the selected content into the destination application.

### CROSS-REFERENCE TO RELATED APPLICATION

The present application is a continuation-in-part of, and claims the benefit of the filing date of, U.S. patent application Ser. No. 10/198,336, filed Jul. 16, 2002, which is hereby incorporated by reference into the present disclosure.

### BACKGROUND

Often, computing device users wish to export content from one user application to another. For instance, where such a user is developing a report at work about a given research topic, the user may conduct research on-line and discover text and/or images that the user would like to export to a user application, such as a word processing application, to develop a written report on the research findings. To cite another example, another user may wish to simply export content from a document of a first user application, e.g., an image from an imaging application, to another document of a second application, e.g., a spread sheet application.

To export content such as in the above-described examples, the user normally is called upon to first select the given content, for instance by highlighting the content using a mouse, and copy the content by, for instance, right-clicking on the selected content and selecting a “copy” command from a pop-up box that appears. Alternatively, the content can be copied by, for example, simultaneously selecting the “ctrl” key and the “C” key of the user's keyboard. Next, if the destination application is not already running, the user must open the destination application by, for example, double-clicking on an icon provided on the user's desktop or selecting the application from a listing of available applications in a start-up menu. To do this, the user may need to exit the source application by, for instance, closing the application or minimizing it.

Once the destination application has been opened, or if it was already open, the user must either create a new document in the destination application or select an existing document from the application, as the case may be. In the former situation, the user will need to either select an icon from a toolbar of the destination application or select a new document command from a menu of the destination application. In the latter situation, the user will need to either access an already open document, or open the desired document if not currently open. If the desired document is already open, the user will need to select the document by, for instance, selecting an appropriate icon presented in the user desktop interface. Notably, time may be required to determine which icon represents the desired document where several documents and/or applications are currently open.

If the desired document is not already open, the user will need to first select an appropriate icon of the destination application toolbar or select an open document command from another menu of the destination application. Next, the user must browse through a listing of various documents stored in the format of the destination application and then select the desired document by, for example, highlighting it and selecting an “open” button.

After a new document or the existing document has been opened, or after accessing an already open document, the user can insert the selected content by, for example, right-clicking within the document and selecting a “paste” command. Alternatively, the user can use an appropriate short-cut key sequence (e.g., simultaneous selection of the “ctrl” key and the “V” key of the user's keyboard). At this point, the user can arrange the content within the destination application document as desired.

As can be appreciated from the process described above, the exportation of content from one user application to another is labor-intensive. Specifically, the process typically involves a multiplicity of key or mouse strokes, manual switching between multiple applications, manual opening of files, etc. Although the process is not difficult per se, it can be tedious. Therefore, it can be appreciated that it would be desirable to have systems and methods with which this process is at least partially automated for the user to reduce the amount of work required of the user to export content.

### SUMMARY

Disclosed are systems and methods for exporting content. In one embodiment, a system and a method pertain to determining user content and destination selections based upon content dragged to and dropped on an icon representing a destination application, copying the selected content, and inserting the selected content into the destination application.

### BRIEF DESCRIPTION OF THE DRAWINGS

The disclosed systems and methods can be better understood with reference to the following drawings. The components in the drawings are not necessarily to scale.

FIG. 1 is a block diagram that illustrates exporting of content from one or more content sources to a content destination.

FIG. 2 is a schematic diagram of a computing system that can be used to export content from one application to another in the manner illustrated in FIG. 1.

FIG. 3 is a flow diagram of an example method for content exportation using the system shown in FIG. 1.

FIGS. 4A and 4B provide a flow diagram of operation of an export utility of the computing system of FIG. 2 in facilitating content exportation.

FIGS. 5A-D are schematic views of a source application during part of an example content exporting process.

### DETAILED DESCRIPTION

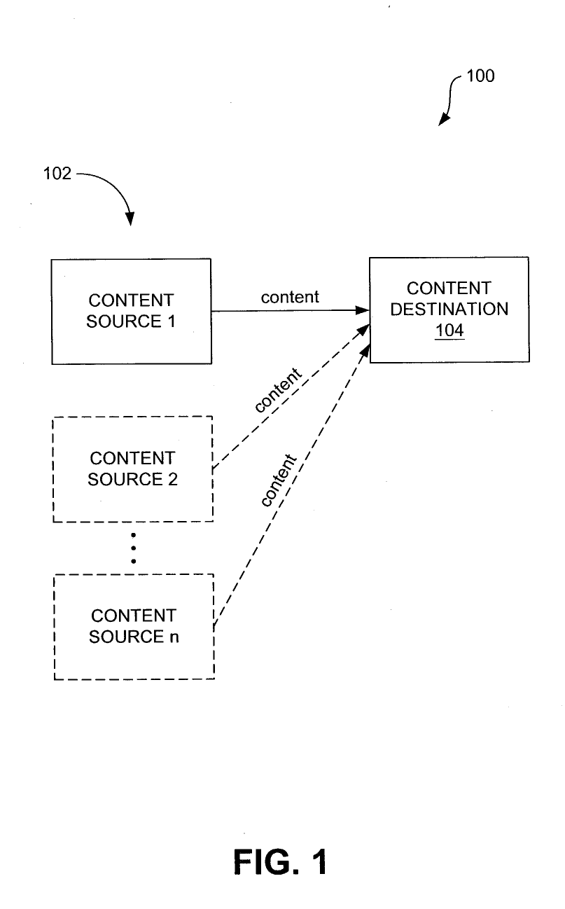

Referring now in more detail to the drawings, in which like numerals indicate corresponding parts throughout the several views, FIG. 1 illustrates a generalized system 100 for exporting content. As indicated in this figure, the system 100 generally comprises one or more content sources 102 (i.e., content sources 1 through n) and a content destination 104. The content sources 102 and content destination 104 typically comprise user applications which can be executed by one or more appropriate computing systems, for example, a personal computer (PC), a personal digital assistant (PDA), etc. The user applications can comprise substantially any user application including word processing applications, spread sheet applications, drawing applications, imaging applications, browser applications, presentation applications, scheduling applications, etc. The content can comprise any content that can be supported by the content sources 102 and the content destination 104. For instance, the content can comprise text, drawings, images, and the like.

As indicated in FIG. 1, the content can be supplied to the content destination 104 from the content sources 102. In some situations, this may entail the provision of content from multiple sources to a single content destination 104. Although not indicated in FIG. 1, content can also be provided from the content source(s) 102 to multiple different content destinations, if desired. As is discussed in greater detail below, the exportation of content is, at least in part, automated for the user so as to reduce the tedium normally involved with exporting content from one application to another.

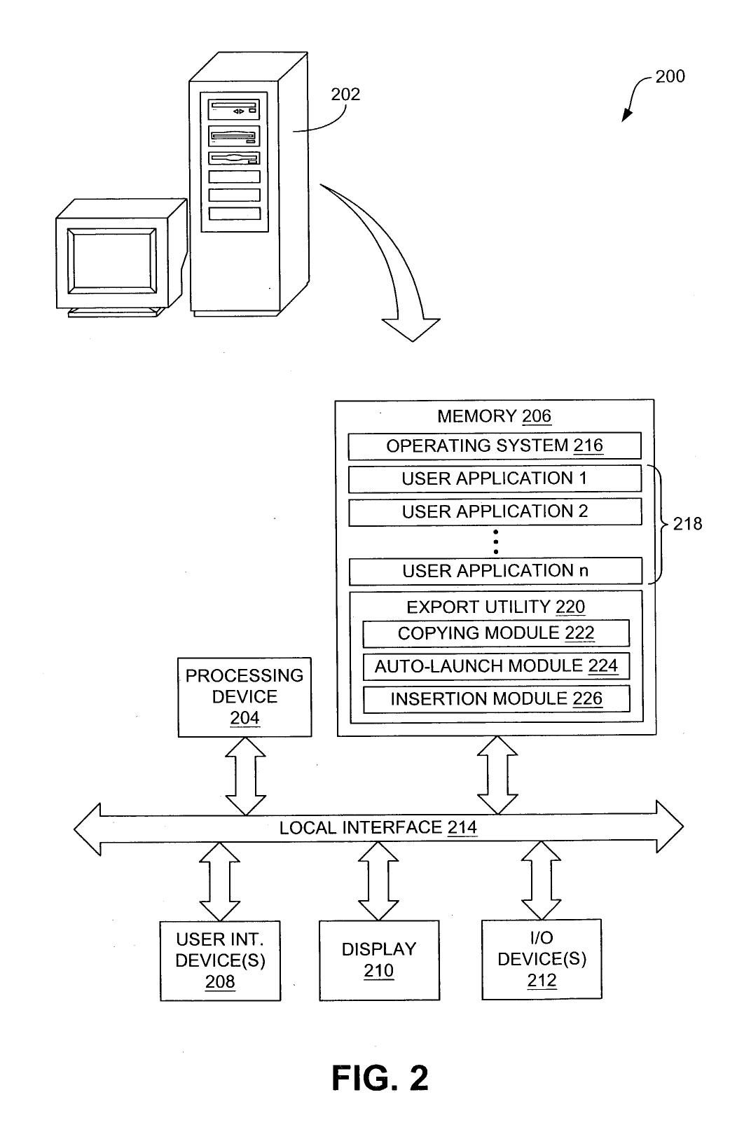

FIG. 2 is a block diagram of an example architecture for a computing system 200 that can facilitate sharing of content between user applications. As is apparent from FIG. 2, the computing system 200 is represented as a computing device, namely a desktop PC 202. Although such a computing device is depicted in the figure and described herein, this computing device is illustrated and described as an example only for purposes of discussion. Therefore, alternative computing systems may be used, if desired.

As indicated in FIG. 2, the computing system 200 comprises a processing device 204, memory 206, one or more user interface devices 208, a display 210, and one or input/output (I/O) devices 212, each of which is connected to a local interface 214 that can comprise one or more internal and/or external buses. The processing device 204 can include any custom made or commercially available processor, a central processing unit (CPU) or an auxiliary processor among several processors associated with the computing system 200, a semiconductor based microprocessor (in the form of a microchip), or a macroprocessor. The memory 206 can include any one of a combination of volatile memory elements (e.g., RAM, such as DRAM, SRAM, etc.) and nonvolatile memory elements (e.g., ROM, hard disk, tape, CDROM, etc.).

The one or more user interface devices 208 comprise those components with which the user can interact with the computing system 200. By way of example, these components can comprise a keyboard and mouse, one or more buttons or function keys, a display, a stylus, etc. The display 210 may comprise, for instance, a cathode ray tube (CRT) or liquid crystal display (LCD).

The one or more I/O devices 212 comprise components used to facilitate connection of the computing system 200 to other systems. These I/O devices 212 can, for instance, comprise one or more serial, parallel, small system interface (SCSI), universal serial bus (USB), IEEE 1394 (e.g., Firewire™), or personal area network (PAN) connection devices.

Stored in memory 206 are several programs including an operating system 216, one or more user applications 218 (i.e., applications 1 through n), and an export utility 220. The operating system 216 controls the general operation of the computing system 200. The user applications 218 comprise one or more programs that serve as a content source and/or a content destination. As indicated above with reference to FIG. 1, these applications may comprise, for example, word processing applications, spread sheet applications, drawing applications, imaging applications, browser applications, presentation applications, scheduling applications, etc. Examples of commonly available user applications include, for example, Word™, Excel™, Corel Draw™, Visio™, Acrobat™, Internet Explorer™, Navigator™, Outlook™, Paint™, PhotoShop™, Power Point™, Quicken™, and so forth.

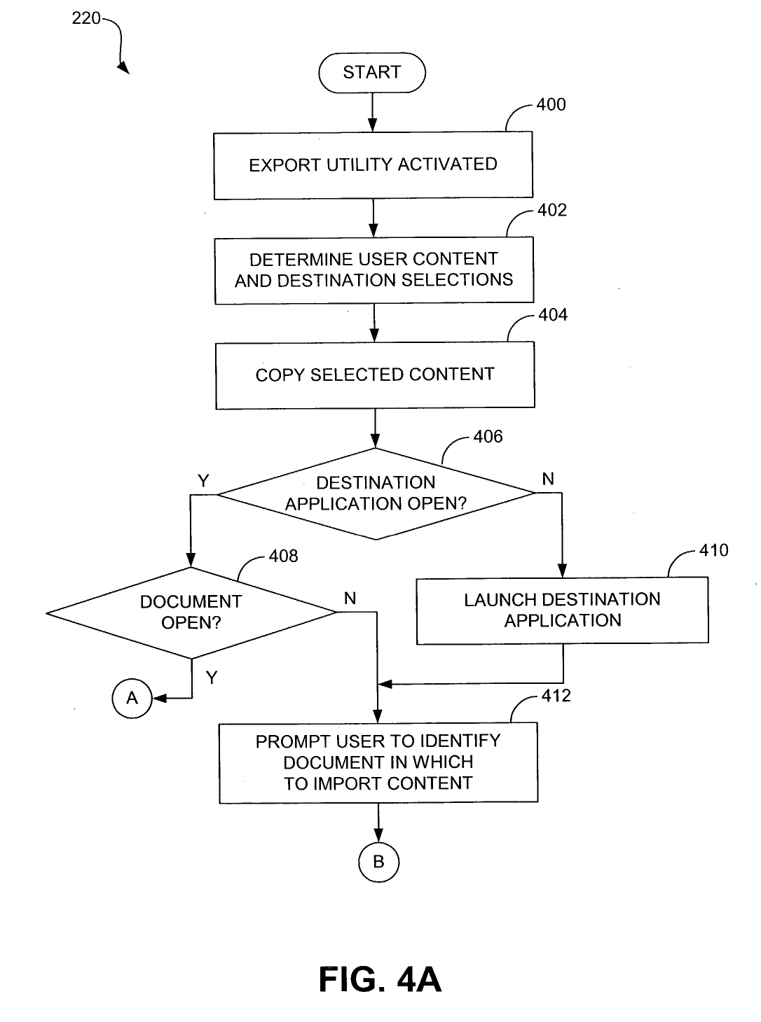

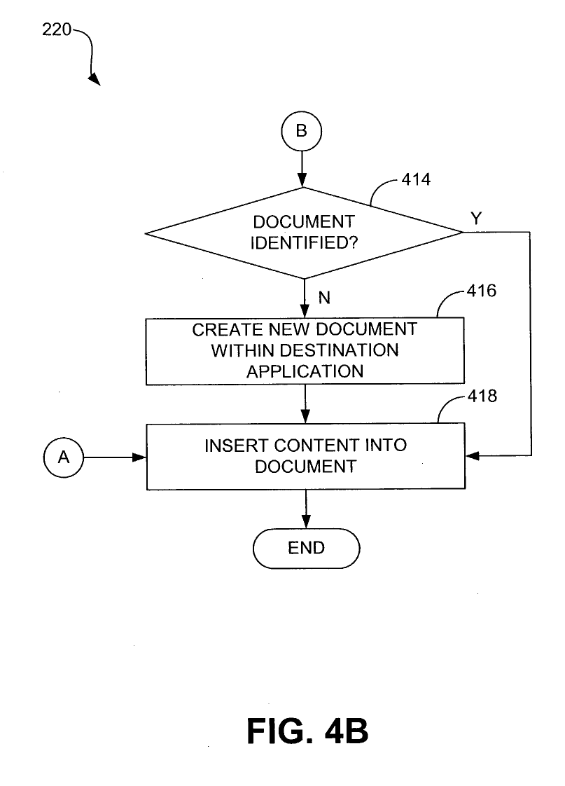

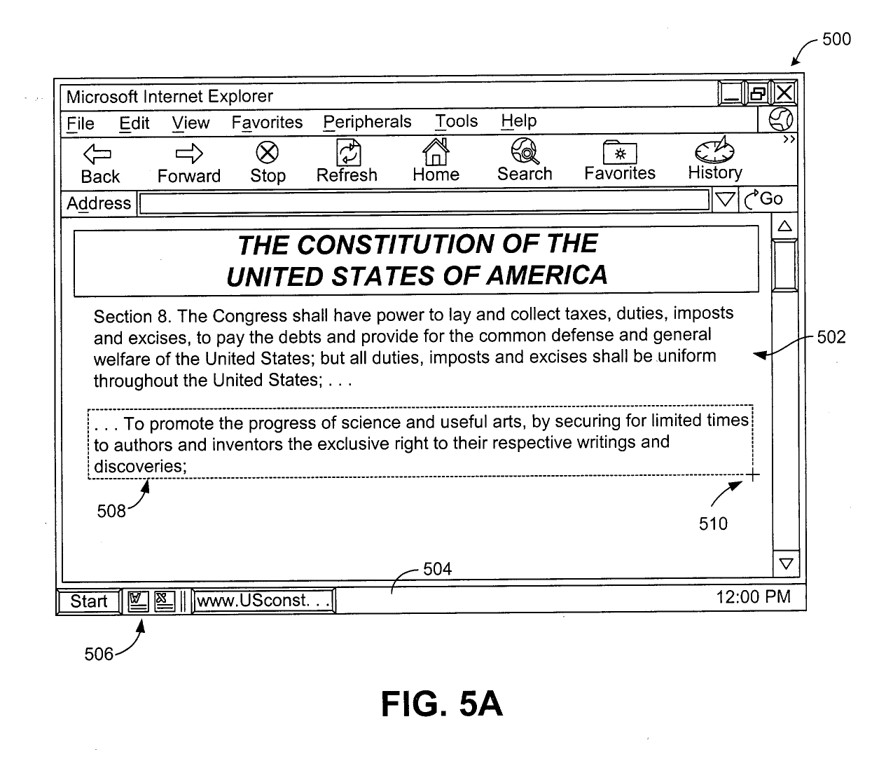

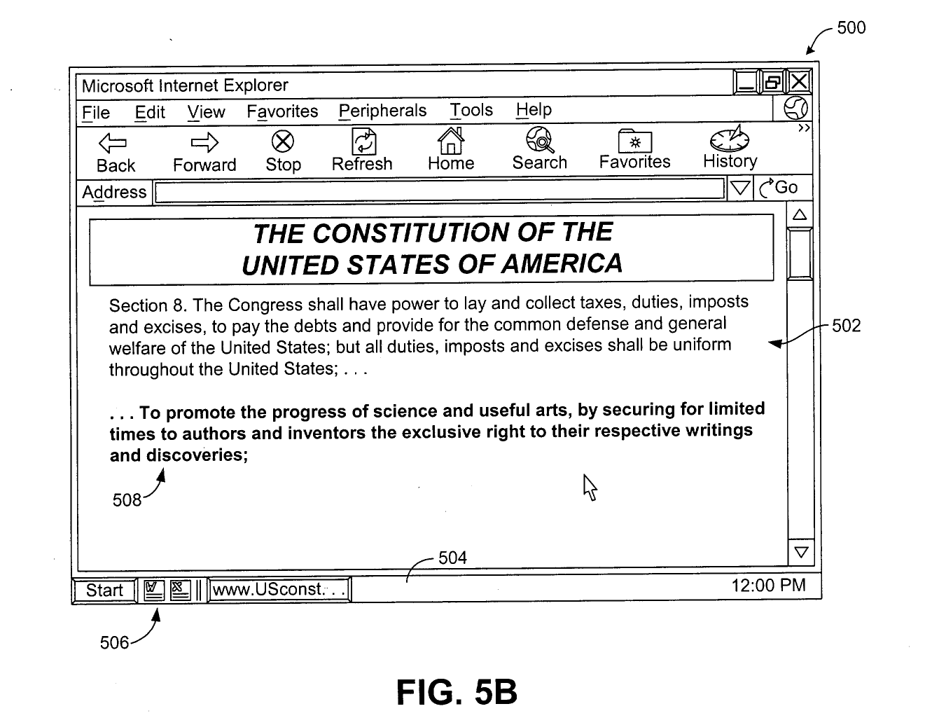

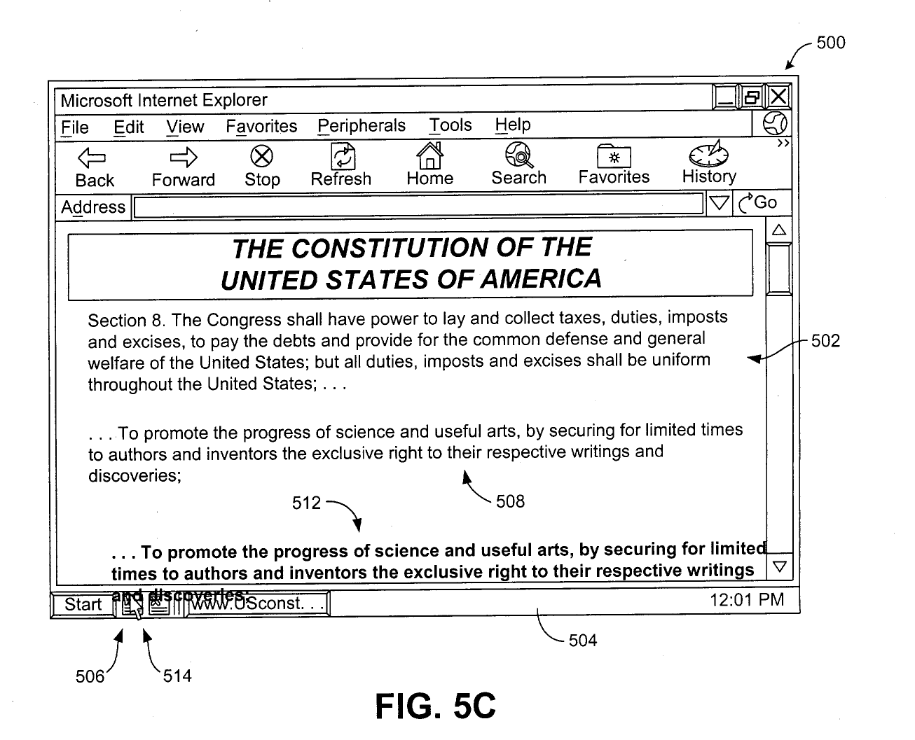

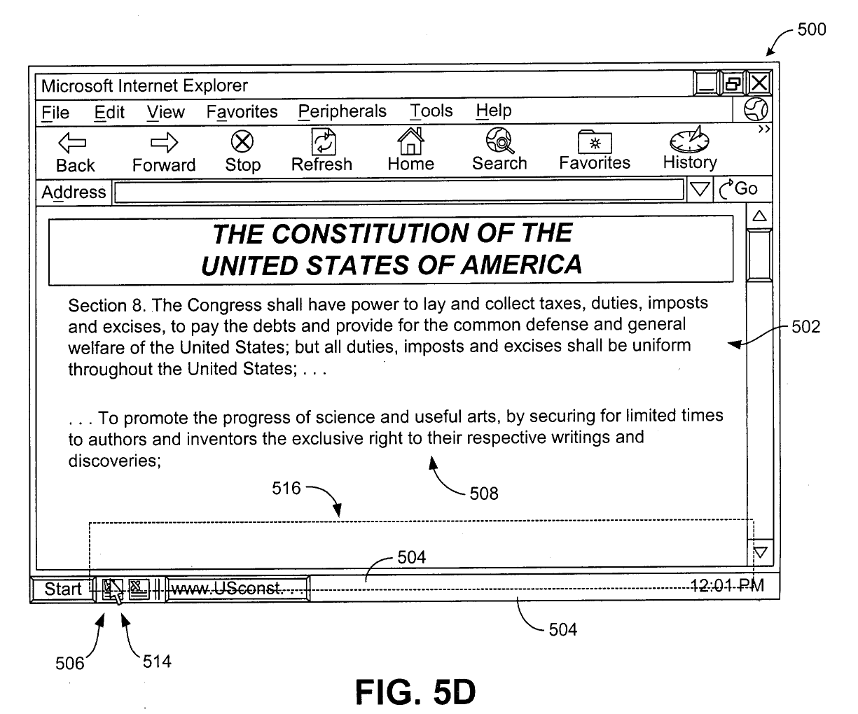

The export utility 220 is a program (software and/or firmware) that is used to, at least partially, automate the exporting of content from content sources to content destinations and, more particularly, the exportation of content from a source application to a destination application. The export utility 220 can comprise, for instance, a copying module 222 that is used to copy selected content, an auto-launch module 224 that is used to automatically launch selected destination documents and/or applications, and an insertion module 226 that is used to insert the selected content into the destination file and/or application. Although the export utility 220 has been identified as a separate program, the utility can, alternatively, comprise a collection of various modules or instructions that are integrated into another program such as the O/S 216. Regardless, however, the functionality of the utility 220 is the same. Operation of the export utility 220 is described in more detail with reference to FIGS. 4-5 below.

Various programs have been identified above. These programs can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. The program can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. A “computer-readable medium” can be any means that can store, communicate, propagate, or transport the program for use by or in connection with the instruction execution system, apparatus, or device.

The computer-readable medium can be, for example, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, RAM, ROM, an erasable programmable read-only memory (EPROM, EEPROM, or flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

As identified above, exporting content from one user application to another user application can be tedious for the user. Using the systems and methods described herein, however, the process can be, at least partially, automated to reduce the amount of work required of the user. In the discussion of example content exporting processes, flow diagrams are provided. Any process steps or blocks in these flow diagrams may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

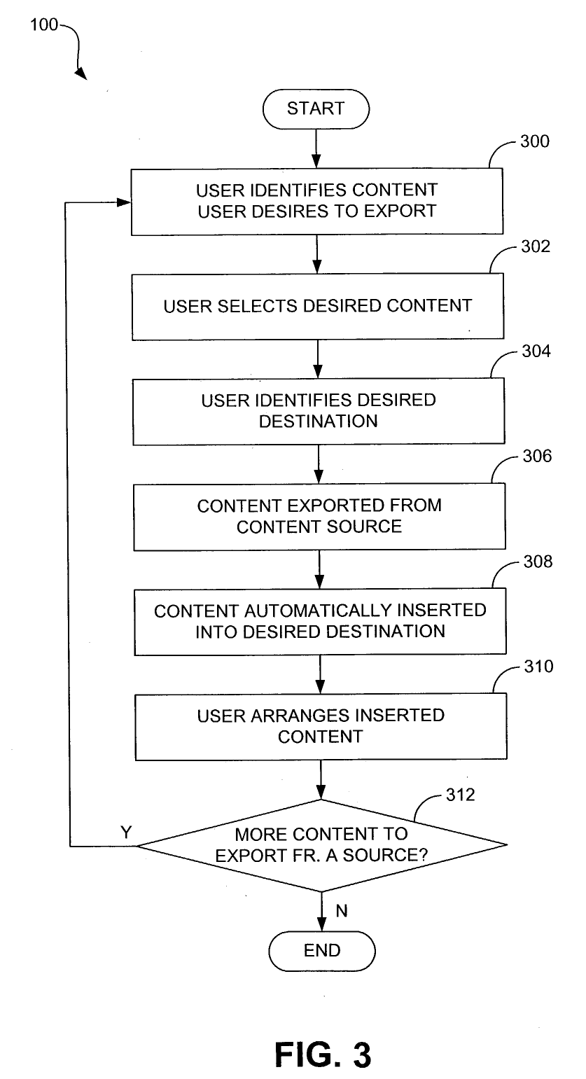

FIG. 3 provides an overview of one example method for exporting content. More specifically, FIG. 3 illustrates an example method for exporting content from a source application to a destination application. Beginning with block 300, the user first identifies content that the user desires to export. This content is identified in a first user application that can comprise, for example, a word processing application, spread sheet application, drawing application, imaging application, browser application, presentation application, scheduling application, or the like. The content may comprise substantially any content that can be copied from one application and inserted into another, for example, text, drawings, icons, images, etc.

Once the user has identified the content the user would like to export, the user selects the desired content, as indicated in block 302. The content can be selected in various ways. Typically, the content is selected using a mouse or an equivalent user interface device. In such a case, the user can, for instance, highlight the desired content by left-clicking with the mouse, passing an on-screen cursor over the desired content, and releasing the mouse button. In an alternative method, the user may use various keystrokes to select the desired content (e.g., using the “Tab” key).

Once the content has been selected, the user identifies the desired destination for the content, as indicated in block 304. As is described in greater detail below, this destination is typically identified using a “drag-and-drop” procedure. The destination typically comprises another application separate from the source application. By way of example, the other application may comprise a word processing application, spread sheet application, drawing application, imaging application, browser application, presentation application, scheduling application, or the like.

After the user has identified the desired destination, the selected content is exported from the source application, as indicated in block 306, and then is automatically inserted into the desired destination (i.e., destination application), as indicated in block 308. This step may involve one or more of automatically launching the destination application, creating a new document within the destination application, opening an existing document of the destination application, and pasting the content into a desired document of the destination application.

Once the content has been inserted into the destination application, the user can arrange the content into a desired format, as indicated in block 310. Next, with reference to decision block 312, it is determined whether more content is to be exported from a source application to a destination application. If so, flow returns to block 300 described above. If not, flow for the exporting session is terminated.

FIGS. 4A and 4B illustrate an example of operation of the export utility 220 shown in FIG. 2 during an exportation process. It is noted that, although specific steps are described in FIGS. 4A and 4B, and specific interfaces shown in FIGS. 5A and 5B, these steps and interfaces are merely illustrative of one embodiment of the exporting process.

Beginning with block 400 of FIG. 4A, the export utility 220 is first activated. As discussed above, this activation typically occurs in response to a drag-and-drop procedure conducted by the user. In such a procedure, the user drags the selected content to an icon presented to the user either on the user interface desktop or in an appropriate toolbar. An example of a typical drag-and-drop procedure is illustrated in FIGS. 5A-5D, which depict a browser application (i.e., Microsoft Internet Explorer™) as the source application. As indicated in these figures, the browser application comprises an application interface 500 that includes a window 502 in which various content is presented and a bottom toolbar 504 in which icons 506 for various destination applications are presented.

Beginning with FIG. 5A, illustrated is the process of selecting a portion 508 of content, in this example text. This portion 508 of content may be selected by, for instance, left-clicking with a mouse and dragging an on-screen cursor 510 over the content (from left to right in this example). Once this step has been completed, the mouse button may be released such that the selected content is highlighted, as indicated in FIG. 5B.

Next, the selected content may be dragged to the icon 508 associated with the desired destination application. FIG. 5C shows one example of this process. In this example, a copy 512 of the selected portion 508 of content is dragged to the icon 508 with another on-screen cursor 514 while holding the left mouse button. In an alternative example shown in FIG. 5D, an outline 516 of the selected portion 508 is instead dragged to the icon 506 using the cursor 514 while holding the left mouse button. In any case, the left mouse button may be released while the cursor 512 is positioned over the icon 506 to “drop” the content into the desired destination application. In the example shown in FIGS. 5A-D, this destination application is Microsoft Word™. For eligible destination applications, the export utility is configured to recognize that content is being dragged to and dropped on the icon representing the destination application in similar manner to desktop “trash bin” icons common with several operating systems.

Through the drag-and-drop procedure described above, the user not only initiates the export utility 220, but also identifies both the content to be exported as well as the intended destination. This procedure initiates the automated exportation of the selected content. Accordingly, with reference back to FIG. 4A, the export utility 220 may determine the user content and destination selections, as indicated in block 402. At this point, the selected content is copied, as indicated in block 404, for instance by the copying module 222. Next, with reference to decision block 406, the export utility 220 determines whether the destination application is already open (in which case the icon identifies an already open application). If so, an existing document to which the user would like to export content may already be open. Therefore, with reference to decision block 408, it is determined whether a document is open in the destination application. If so, flow continues to block 418 of FIG. 4B. If not, flow continues on to block 412 described below.

Returning to decision block 406, if the destination application is not already open (in which case the icon is that used to launch the application), flow continues to block 410 and the destination application is launched, for example by the auto-launch module 224. This launching is “automatic” in that the user need not complete the separate step of selecting (e.g., double-clicking) an icon representing the application. Instead, dragging content to the icon initiates launching of the application. Therefore, the automatic launching of the destination application removes the tedium normally involved in locating and manually opening the application. Once the destination application has been launched, or if it was already open but no document was open (decision element 408), the export utility 220 may prompt the user to identify a document in which to import the content. For instance, the user can be queried as to whether he or she would like to insert the content into an existing document with a pop-up dialog box in which the user can browse one or more file directories.

With reference to FIG. 4B and decision block 414, if no document is identified by the user, the user presumably wishes to insert the content into a new document and, as indicated in block 416, the export utility 220 creates a new document within the destination application. At this point, the selected content can be inserted into the pertinent document of the destination application, as indicated in block 418, for instance by the insertion module 226. Accordingly, whether an existing document was open (block 408), whether the user selected an existing document (block 414), or whether the user designated the destination application generally (block 416), the content from the source application is inserted, i.e., pasted, into a document of the destination application.

With the mode of operation described above with reference to FIG. 3 and FIGS. 4A and 4B, the content exporting process is substantially automated to reduce the amount of work required of the user to import content into a desired destination application and/or document. Therefore, exportation can be accomplished both more quickly and efficiently with less user frustration.

While particular embodiments have been disclosed in detail in the foregoing description and drawings for purposes of example, it will be understood by those skilled in the art that variations and modifications thereof can be made.

What is claimed is:

1. A method for exporting content from a source application to a destination application, comprising:
selecting content within the source application;
dragging the content to an icon representing the destination application; and
dropping the content on the icon so as to initiate the insertion of the content into a document of the destination application.

2. The method of claim 1, wherein the step of selecting content comprises highlighting content using a mouse.

3. The method of claim 1, wherein the step of dragging the content comprises moving the content with a mouse while holding a mouse button.

4. The method of claim 1, wherein the step of dropping the content comprises releasing a mouse button while the content is aligned over the icon.

5. The method of claim 1, wherein the step of dragging the content comprises dragging the content to an icon located in a desktop toolbar.

6. The method of claim 1, further comprising selecting an existing document of the destination application in which to insert the selected content.

7. A method for exporting content from a source application to a destination application, comprising:
determining user content and destination selections based upon content dragged to and dropped on an icon representing the destination application;
copying the selected content; and
inserting the selected content into the destination application.

8. The method of claim 7, wherein the step of determining comprises determining content and destination selections based upon content dragged to and dropped on an icon using a mouse.

9. The method of claim 7, wherein the step of inserting the selected content comprises inserting the selected content into a newly created document of the destination application.

10. The method of claim 7, wherein the step of inserting the selected content comprises inserting the selected content into an existing document of the destination application.

11. The method of claim 7, further comprising launching the destination application.

12. The method of claim 7, further comprising creating a new document in the destination application in which the selected content will be inserted.

13. The method of claim 7, further comprising querying a user to identify an existing document of the destination application into which to insert the selected content.

14. A system for exporting content from a source application to a destination application, comprising:
an export utility including:
a copying module configured to copy content dragged to and dropped on an icon representing the destination application;
an auto-launch module configured to automatically launch the destination application when the content is dropped on the icon; and
an insertion module configured to insert the content into the destination application.

15. The system of claim 14, wherein the insertion module is configured to insert the content into an existing document of the destination application.

16. The system of claim 15, wherein the export utility is configured to query the user as to the existing document into which to insert the content.

17. The system of claim 14, wherein the export utility is configured to create a new document in the destination application.

18. An export utility stored on a computer-readable medium, comprising:
logic configured to determine content of a source application that a user wishes to export;
logic configured to determine a destination application to which the user wishes to import the content;
logic configured to copy the selected content; and
logic configured to insert the copied content into the destination application.

19. The utility of claim 18, wherein the logic configured to determine content comprises logic configured to determine selected content based upon a drag-and-drop procedure conducted by the user.

20. The utility of claim 18, wherein the logic configured to determine content comprises logic configured to determine selected content based upon the dragging of content to and the dropping of the content on an icon that represents the destination application.

21. The utility of claim 18, wherein the logic configured to determine a destination application comprises logic configured to determine a destination application based upon the dropping of the content on an icon that represents the destination application.

22. The utility of claim 18, wherein the logic configured to insert is configured to insert the content in an existing document.

23. The utility of claim 18, further comprising logic configured to create a new document in the destination application.

24. The utility of claim 23, wherein the logic configured to insert is configured to insert the content in the newly created document.

25. A computing system, comprising:
a processing device; and
memory including a content exporting program including logic configured to determine content of a source application based upon a user drag process, logic configured to determine a destination application to import the content based upon a user drop process, logic configured to copy the selected content, and logic configured to insert the copied content into the destination application.

26. The system of claim 25, further comprising logic configured to create a new document in the destination application.
